(19) United States
(12) Patent Application Publication
(10) Pub. No.: US 2026/0362570 A1
(43) Pub. Date: Nov. 12, 2026

(54) LIGHTING DEVICE WITH A MEMORY AND CONTROLLER FOR STORING DATA IN THE MEMORY

(71) Applicant: SIGNIFY HOLDING B.V., EINDHOVEN (NL)

(72) Inventors: EVREN ÖZCAN, EINDHOVEN (NL); PETER DEIXLER, ARLINGTON, MA (US)

(21) Appl. No.: 19/488,117

(22) PCT Filed: May 17, 2024
(86) PCT No.: PCT/EP2024/063815

§ 371 Date: Nov. 26, 2025

Related U.S. Application Data
(60) Provisional application No. 63/470,063, filed on May 31, 2023.

(30) Foreign Application Priority Data
Jun. 15, 2023 (EP) 23179544.4

(51) Int. Cl. H05B 47/135; H05B 47/165; H05B 47/175

(52) U.S. Cl. CPC H05B 47/135; H05B 47/165; H05B 47/196

(57) ABSTRACT

A lighting device (1) is disclosed that comprises a light source (12) configured to generate light, a memory (10) configured to store data and a controller (8). The controller (8) is configured to store first data in the memory (10), the first data being indicative of at least one of one or more (natural) resources usage or one or more potential environmental impacts which is caused by operations carried out in relation to manufacturing of the lighting device. The controller (8) is further configured to prevent adjusting the first data stored in the memory. The controller (8) is further configured to store second data in the memory (10), the second data being indicative of at least one of one or more natural resources usage or one or more potential environmental impacts which is caused by operations carried out in relation to the lighting device during the lifetime thereof after the manufacturing has been completed.

### TECHNICAL FIELD

The present invention relates to a lighting device with a memory and a controller for storing data in the memory. The present invention further relates to a method for storing data in the memory of the lighting device. The present invention further relates to a computer program product for executing the method according to the invention. The present invention further relates to a lighting system comprising the lighting device according to the invention.

### BACKGROUND

A lighting device may include one or more light sources, the operation of which may be controlled individually. Thereby, the light emission of each light source may controlled, for example by a controller or control device which may be included in the light generating device. Such light sources or lighting devices may for example comprise or be constituted by one of more solid-state light sources.

US2010/251157A discloses the integration of an energy function into a light management system for saving energy and monitoring energy consumption. The light management system has an integrated energy function, wherein the system is adapted to receiving energy information about light fixtures of a lighting system, and to processing the received energy information with regard to energy consumption of the lighting system. The energy function is used to automatically configure a lighting system to low energy consumption, to allow further configurations of the lighting system with regard to lowering energy consumption, or to provide a user with a sensible set of lights that can be turned off and will amount to significant energy savings when turned off.

US2011/234095A discloses an integrated gas discharge lamp, wherein the gas discharge lamp burner and operating electronics for the gas discharge lamp burner are integrated in a lamp, and wherein the operating electronics control the power of the gas discharge lamp burner as a function of the burning time thereof in such a way that the level of the light output of the integrated gas discharge lamp follows a predetermined target value curve.

Wang Shuyi, et. al., “Environmental and social life cycle assessment of an industrial LED lighting product”, Environmental Impact Assessment Review, Elsevier, Amsterdam, NL, vol. 95, 17 May 2022, presents the environmental and social assessment of an industrial LED lighting product along its supply chain. It proposes to assess a product's supply chain from both environmental and social perspectives, not only to identify the issues and risks but also to have a holistic understanding of the product's life cycle so that opportunities can be detected. The integration of environmental life cycle assessment and social life cycle assessment into the lighting product sustainability assessment and its outcomes are novel contributions to the sustainable LED lighting products and service innovation.

### SUMMARY

Life Cycle Assessment (LCA) is a methodology that may be used to assess potential environmental impacts associated with the entire lifecycle of a product. The lifecycle of a product may include the following stages: (1) extraction of raw material needed for the product, (2) processing related to the making of the product (e.g., manufacturing), (3) shipping, or transportation, carried out in relation to the product, (4) use of the product by the user(s), and (5) disposal of the product at the end of its lifecycle. LCA may alternatively be referred to as Life Cycle Analysis. In order to assess potential environmental impacts associated with the entire lifecycle of a product, all relevant inputs from the environment (e.g., ores, crude oil, water, land use, etc.) as well as emissions into air, water and soil (e.g., carbon dioxide and nitrogen oxides) may be considered. The International Organization for Standardization provides guidelines and requirements for conducting an LCA according to ISO 14040 and ISO 14044.

LCA methodologies and possibly any similar methodologies may be used to assess potential environmental impacts associated with the entire lifecycle of a lighting device, e.g., a lighting device comprising or being constituted by one of more solid-state light sources such as light-emitting diodes (LEDs). The inventors have realized that it would be desirable to take into account potential environmental impacts associated with lighting devices during their operation, whereby potential environmental impacts which may be associated with such a lighting device may be reduced.

In view of the above, a concern of the present invention is to provide means for facilitating or allowing for reducing any potential environmental impacts which may be associated with the manufacturing, distribution, and use of a lighting device during its lifetime.

To address at least one of this concern and other concerns, a lighting device, a method, a computer program product and lighting system in accordance with the independent claims are provided. Preferred embodiments are defined by the dependent claims.

According to a first aspect, a lighting device according to claim 1 is provided.

Hence, the invention provides a lighting device comprising: a light source configured to generate light; a memory configured to store data; a controller configured to:

store first data in the memory, the first data being indicative of at least one of one or more (natural) resources usage or one or more (potential) environmental impacts which is caused by operations carried out in relation to manufacturing of the lighting device; prevent adjusting the first data stored in the memory (e.g. after the manufacturing and/or installation of the lighting device has been completed); store second data in the memory, the second data being indicative of at least one of one or more (natural) resources usage or one or more (potential) environmental impacts which is caused by operations carried out in relation to the lighting device during the lifetime thereof after the manufacturing of the lighting device has been completed.

The invention further provides a lighting device comprising: a light source configured to generate light; a memory configured to store data; a controller configured to: store first data in the memory, the first data being indicative of at least one of one or more (natural) resources usage or one or more environmental impacts which at least one or more natural resources usage or one or more environmental impacts is caused by operations carried out in relation to manufacturing of the lighting device; prevent adjusting the first data stored in the memory (e.g. after the manufacturing and/or installation of the lighting device has been completed); store second data in the memory, the second data being indicative of at least one of one or more (natural) resources usage or one or more environmental impacts which at least one or more natural resources usage or one or more environmental impacts is caused by operations carried out in relation to the lighting device during the lifetime thereof after the manufacturing of the lighting device has been completed, wherein the memory is configured to store a predetermined transformation function, wherein the controller is configured to apply the predetermined transformation function to convert the first data and second data stored in the memory into an environmental impact value for at least one impact category.

According to a second aspect, a method according to claim 12 is provided for a lighting device according to the first aspect.

According to a third aspect, a computer program product according to claim 13 is provided. The computer program product comprises instructions which, when executed by one or more processors of a controller of a system according to the first aspect, cause the controller to carry out a method according to the second aspect.

According to a fourth aspect, a lighting system according to claim 14 is provided. The lighting system comprises a lighting device according to the first aspect.

The first (LCA) data may for example be values representative of the at least one (natural) resource usage or values representative of the at least one (potential) environmental impact, which is caused by operations carried out in relation to manufacturing of the lighting device, that are determined for the lighting device. The second (LCA) data may for example be values representative of the at least one (natural) resource usage or values of the at least one (potential) environmental impact, which is caused by operations carried out in relation to the lighting device during the lifetime thereof after the manufacturing of the lighting device has been completed, that are determined for the lighting device. The larger the values of the first and/or second data of at least one potential environmental impact of a lighting device, the larger the at least one potential environmental impact of the lighting device may be. Thus, if comparing two lighting devices having different values for the first and/or second data for at least one potential environmental impact, the lighting device having the largest value of at least one potential environmental impact may be considered to be the less environmentally sustainable lighting device of the two lighting devices.

As mentioned, it is prevented that the first (LCA) data stored in the memory are adjusted, for example after the manufacturing of the lighting device is completed. Completion of the manufacturing of a lighting device can be determined by a positive result of a test performed in the factory, for example. By preventing the first data from being adjusted it is guaranteed that at some point in time these first data are fixed in order to guarantee a correct comparison of the environmental impact between different lighting devices. In addition, in case the lighting device is controlled by the controller based the first data or based on information derived from the first data, fixing of these first data allows a more reliable control of the lighting device in relation to its environmental impact. For preventing the first (LCA) data stored in the memory are adjusted, so-called write one, read many (WORM) data technology may be used. WORM is a data storage technology that allows data to be written to a storage medium a single time and prevents the data from being erased or modified. Memories that support WORM storage are purposely non-rewritable to prevent anyone from intentionally or accidently erasing or modifying the data after it is initially stored.

A (natural) resource may be, for example, a metal, crude oil, natural gas, wood, water, polymer materials, etc.

Environmental impacts may relate, for example, to waste generation, releases to air, water, or soil, etc. The wording “releases” may refer to a gas, a liquid or a solid that is generated as a result of the operation of a lighting device. An example of a release to air may be the release of carbon dioxide that is generated in a power plant for producing electricity that is used during operation of the lighting device.

Prevent adjusting the first data may mean prevent removing the first data, and/or prevent decrementing the first data and/or prevent reducing the first data.

The second data may be further related to recycling of the lighting device.

The predetermined transformation function converts the use of a (natural) resource or environmental impact into an environmental impact value.

The environmental impact value represents the impact of a (natural) resource or environmental impact for a certain impact category in an equivalent unit.

An impact category means a class representing environmental issues of concern to which life cycle inventory analysis results may be assigned. Examples of impact categories are: climate change, eutrophication, land use, resource depletion, acidification, ozone depletion, ecotoxicity, ionizing radiation, photochemical ozone formation, water depletion, human toxicity, etc.

The equivalent unit is a unit that is used to determine the environmental impact value for a certain impact category.

The impact value for at least one impact category means a quantifiable representation of an impact category in terms of the equivalent unit. By each of the lighting device being configured to store and optionally obtain first and second data indicative of at least one of one or more (natural) resources usage or one or more (potential) environmental impacts which is caused by operations carried out in relation to the lighting device from its manufacture and during the lifetime thereof, and by optionally controlling operation of at least one of the plurality of lighting devices based on the measures of the at least one resource usage and/or the measures of the at least one (potential) environmental impact determined for the respective ones of the lighting devices, the environmental impact of the lighting device may be determined more accurately at any point during its life time or at end of life of the lighting device. This allows for a new realm of lighting device control, e.g. selection of which lighting device to replace or selection of which lighting device to use. For example, it allows for a use a scheme in which operation of a lighting device that is considered to be environmentally sustainable is prioritized over operation of any lighting device of the system that is not considered to be environmentally sustainable, or at least less environmentally sustainable. For example, in case two lighting devices of the lighting system are able to provide a particular lighting functionality (e.g., ambient lighting) and a first of the two lighting devices is considered to be environmentally sustainable but the second is not, or of the second lighting device is considered less sustainable, or if the second lighting device has a value of at least one (potential) environmental impact that is larger than that of the first lighting device, the first lighting device may be operated to render the lighting functionality, but not the second lighting device. Similarly, when making a selection for which lighting device to replace with a new one, in case a first of two lighting devices is considered to be environmentally more sustainable than a second one, or if the second lighting device has a value of at least one (potential) environmental impact that is larger than that of the first lighting device, the second lighting device may be preferably be selected for replacement. Another example application is streetlighting. Turning on streetlights may be triggered by presence detection, such that if presence of one or more persons in the vicinity of a group of streetlights is detected, the streetlights are turned on so as to emit light. However, if the function of turning on the light can sufficiently be achieved by one streetlight within the group of streetlights, only the streetlight considered to be environmentally sustainable of the group of streetlights may be turned on. According to another example, operation of the lighting devices may be controlled based on a property of resource usage. For example, in case each of the lighting devices of the system is able to provide a relatively energy-demanding lighting functionality (e.g., entertainment lighting), only the lighting device(s) of the system for which the measure or value of the at least one resource usage is not exceeding a (e.g., predefined) threshold (value) may be operated to provide that lighting functionality. The other one(s) of the lighting devices of the system may not be operated to provide that lighting functionality, as it already may have a relatively high resource usage (e.g., energy) so far (during its lifetime), as indicated by the measure or value of the at least one resource usage thereof exceeding the (predefined) threshold (value). According to another example, operation of the lighting device(s) of the system considered to be environmentally unsustainable, or at least less environmentally sustainable, than other lighting device(s) of the system may be prioritized over operation of the other lighting device(s) of the system. This may for example be done in order to reduce the lifetime of the lighting device(s) of the system considered to be environmentally unsustainable, or at least less environmentally sustainable, by controlling that or those lighting devices to carry out highly electronics-reliability-degrading lighting tasks while sparing the other lighting device(s) of the system from having to carry out such tasks. An example is starting up streetlights during (e.g., extremely) cold weather conditions. It may as an example be assumed that the system includes, e.g., six lighting devices (e.g., streetlights), and that a minimum of three lighting devices are required to be operated in order to meet any lighting regulations. Then, the three lighting devices of the system which are less environmentally sustainable than the other three lighting devices of the system may be controlled to be started up while the other lighting devices are spared from having to be started up during such cold weather conditions. Thereby, the electronics of the three lighting devices of the system which are less environmentally sustainable than the other three lighting devices of the system will degrade faster than the electronics of the other lighting devices, which may lead to earlier failure of the three lighting devices of the system which are less environmentally sustainable than the other three lighting devices, as compared to the other lighting devices.

The lighting device control may be carried out under one or more constraints, which for example may represent what type of control behavior is acceptable to a user of the system. For example, the system may comprise two lighting devices of the same type, e.g., two identical Hue lamps, which for example may be located in a home. The user may set a constraint (e.g., in the controller) that one of the two lighting devices is to be used to provide decorative lighting, with the light emitted having a relatively low brightness, constantly during the night (i.e., not depending on whether presence is detected or not), while the other one of the lighting devices is to be used to provide a relatively high luminous flux at a specific location (e.g., in a hallway, to provide functional lighting), which may be activated only if presence is detected.

For each or any of the plurality of lighting devices, the value of at least one (potential) environmental impact of the lighting device may be derived from data indicative of one or more natural resources usage in the stored data of the lighting device by means of an LCA method. In alternative or in addition, it is contemplated that the value of at least one (potential) environmental impact of the lighting device could be derived from data indicative of one or more (natural) resources usage in the stored data of the lighting device by means of any methodology similar to LCA methodologies. Thus, even if one or more embodiments disclosed herein are described with reference to (e.g., utilization of) an LCA method or LCA methodology, it is to be understood that such embodiment(s) could additionally or in alternative utilize any other method or methodology similar to LCA methods and methodologies. The measure or value of at least one (potential) environmental impact of the respective ones of the lighting devices could for example be derived from applying a transformation, e.g., a transformation function, to the data indicative of one or more (natural) resources usage in the stored data of the lighting device. Such a transformation or transformation function may be predefined, and may for example depend on an LCA methodology that may be used. Thus, the transformation or transformation function may be defined by, or as part of, an LCA methodology that may be used. The transformation or transformation function may be predefined. The transformation or transformation function may be stored in the controller, e.g., in a memory thereof. The transformation or transformation function may for example be in accordance with the guidelines and requirements for conducting an LCA of the International Organization for Standardization according to ISO 14040 and ISO 14044. Said transformation function may for example multiply first and second data indicative of one or more natural resources usage in the stored data of the lighting device with a respective characterization factor. Such characterization factors may for example be derived from the ILCD International Life Cycle Data system of the European Platform on LCA (EPLCA) of the European Commission. See, e.g., the ILCD handbook (ISBN 978-92-79-19092-6; doi: 10.2788/38479). Said transformation function may for example be a vector comprising respective characterization factors to be applied to each one of the (natural) resource usage indicated by the first and second data, so as to find the at least one (potential) environmental impact.

For each or any of the plurality of lighting devices, the data indicative of at least one of one or more natural resources usage or one or more (potential) environmental impacts which is caused by operations carried out in relation to the lighting device from its manufacture and during the lifetime thereof may for example relate to at least one of manufacturing, shipping, storage, installation, use or disposal of the lighting device. The data may be obtained from different entities involved in operations carried out in relation to the lighting device from its manufacture and during the lifetime thereof, such as different entities involved in the manufacturing, shipping, storage, installation, use and/or disposal of the lighting device. In the context of the present application, disposal of a lighting device may mean or involve recycling and/or refurbishing of the lighting device. The first data relating to manufacturing of the lighting device may include data relating to or indicating the use of natural resources needed to manufacture the lighting device. The data relating to installation of the lighting device may include data indicative of one or more (potential) environmental impacts which is caused by external conditions during the installation of the lighting device. For example, the requirement of packaging material and the disposal thereof during installation of the lighting device may be attributed to the lighting device. For example, if the lighting device is a streetlight installed in a tunnel, and if, as a result of the installation of the streetlight, a traffic jam on the roads through and in the vicinity of the tunnel occurred, this could result in an environmental impact, such as increased carbon dioxide emissions, and may hence be indicated in the data.

For each or any of the plurality of lighting devices, the data indicative of at least one of one or more natural resources usage or one or more (potential) environmental impacts which is caused by operations carried out in relation to the lighting device from its manufacture and during the lifetime thereof may for example comprise or be constituted by LCA data. LCA data may for example be provided in an ‘LCA data file’. The LCA data or LCA data file may be associated with a Life Cycle Inventory of the lighting device, which Life Cycle Inventory may be in accordance with or based on LCA methodologies. The LCA data or LCA data file may include data on (e.g., a list) of one or more (e.g., natural) resources usage which is caused by operations carried out in relation to the lighting device from its manufacture and during the lifetime thereof so far, i.e., up to the current point in the lifetime of the lighting device. Such data or list may be referred to as an inventory, or inventory data or inventory table. In accordance with LCA methodologies, the (potential) environmental impact(s) may be determined (e.g., calculated) based on the one or more resources usage (e.g., based on the inventory table). While one or more embodiments disclosed herein are described with reference to “LCA data” or “LCA data file”, it is to be understood that this does not necessarily limit the disclosed embodiments to LCA methods and methodologies; rather the disclosed embodiment(s) could additionally or in alternative utilize any other method or methodology similar to LCA methods and methodologies. In the context of the present application, the expressions “data indicative of at least one of one or more natural resources usage or one or more (potential) environmental impacts which is caused by operations carried out in relation to the lighting device from its manufacture and during the lifetime thereof”, “LCA data”, “LCA data file”, etc., can be used interchangeably without any loss of generality.

LCA methodologies may consider environmental impact during entire life cycle of a product (e.g., a product such as a lighting device), which may involve one or more of the following stages related to the product: (1) raw material extraction, (2) processing (e.g., manufacturing), (3) transportation, (4) use, and (5) disposal at the end of life of the lighting device. As indicated in the foregoing, LCA methodologies may use a Life Cycle Inventory. A Life Cycle Inventory includes data related to the product, which data quantifies all relevant inputs and outputs of the product during the above-mentioned stages. Such data is often estimated.

Each or any of the lighting devices may be configured to store (e.g., in a memory of the lighting device) data, e.g., in the form of an ‘LCA data file’, associated with the Life Cycle Inventory. For each or any of the lighting devices, the data may be updated during the various stages of an LCA, and the lighting device may be configured such that the data can be accessed or retrieved, e.g., by a user, at any given moment in time, for example at the end of life of the lighting device, or at a point in time when second-hand selling the lighting device. When accessed or retrieved, the data provides the inventory data accumulated so far, which can subsequently be transformed (e.g., using a standardized algorithm according to an LCA method) to a measure of a (potential) environmental impact (for various impact categories). This may render an accurate account of the environmental impact of each individual lighting device.

The LCA data file for a lighting device may essentially include a table that lists the resource usage during any of the different stages (1) to (5) as mentioned in the foregoing. The LCA data file may have a predetermined format. Said format may be unique (for a particular LCA methodology). The LCA data file may include several fields, each of which may include the input or output related to a certain resource type. The resource type may be selected accordingly. The resource type may for example be power, electrical energy, water, fuel, copper, nickel, glue, plastic, metal, iron, aluminum, phosphor, paper or other packaging material, fossil fuel, etc. An LCA for a lighting device is often done theoretically. The data representing the inputs and outputs during each stage of the life cycle for the lighting device for establishing a Life Cycle Inventory may be estimated based on averages, especially for the use stage. For example, theoretically, a 17 W light bulb may operate at 1000 lumen on average for 3 hours each day. However, due to the current capabilities of ‘smart’ light bulbs, the exact use of light bulbs during the day may vary significantly. For example, the same light bulb may operate for 8 hours each day at low power consumption with a motion sensor; and can be dimmed, e.g., to ‘entertainment mode’ for 2 hours each evening; and may at days when the user studies emit bright functional light at maximum intensity for as long the studies lasts. Even though the light bulb is the same, the environmental impact can be different at each moment in time from the use stage to the end of life of the light bulb. For example, even comparing lamps being of the same type, one lamp can have had a larger environmental impact compared to another lamp. A particular lamp can if it has anti-burglar functionality installed have a larger environmental impact than if it does not have that functionality installed.

For example, the same lighting devices (e.g. bulb) may be manufactured in China and distributed to various locations in the world, so as to be used at said locations by customers. A same lighting device that is distributed to a customer in the Netherlands by ship, may have larger environmental impact at installation, compared to the same lighting device that is distributed to a customer close to the manufacturing location in China. Hence, even though the lighting devices may be the same, and have the same impact for the life cycle stage of manufacturing, after the lifecycle stage of transportation the same lighting devices may have a different environmental impact. Subsequently, during the lifecycle stage of use, at some point in time, the same lighting device respectively installed in the Netherlands may have a smaller environmental impact compared to the same lighting device respectively installed in China, for example due to differences in the used power mix (e.g. sustainable wind power vs. coal-plant power). Therefore, by the controller of each lighting device storing the first data, preventing the first data to be adjusted, and storing the second data in the memory, improved lighting devices are provided, which enable to determine a respective (potential) environmental impact. The (potential) environmental impact can then be compared, or used to control functions of the lighting device or groups of lighting devices, for example.

In view of the above, it may be beneficial to store and/or update the LCA data file of a lighting device during the operation of the lighting device, with the data for example being locally stored in the lighting device. For example, at the end of life of the lighting device, the data stored in the lighting device can thereby be retrieved (for example, when the lighting device is left at a disposal location or recycled or refurbished). Thus, an accurate environmental impact of the lighting device for the duration of its life cycle can be determined (e.g., calculated). The data stored in the lighting device can be retrieved to obtain the inventory data. Subsequently, the inventory data may be characterized into a common unit of a measure of at least one (potential) environmental impact of the lighting device, such as, for example, carbon dioxide equivalent, or some other common unit. The data may thus have a standardized format. The measure may represent the environmental issue(s) of concern to which the Life Cycle Inventory analysis results may be assigned. The at least one (potential) environmental impact may for example includes or be constituted by one or more of global warming (potential) (e.g., expressed in carbon dioxide equivalent) or natural resources depletion.

As mentioned, for each or any of the plurality of lighting devices, the measure of at least one (potential) environmental impact of the lighting device may be derived from data indicative of one or more natural resources usage in the stored data of the lighting device by means of applying a transformation, e.g., a transformation function, to the data indicative of one or more natural resources usage in the stored data of the lighting device. The transformation or transformation function may be predefined, and may for example depend on an LCA methodology that may be used. For example, there are many greenhouse gases being emitted (e.g., resources). Creating a list of the greenhouse gases emitted can provide the resource usage (e.g., inventory table). Using the LCA methodology, a carbon dioxide equivalent of each greenhouse gas (i.e., heat absorbed by greenhouse gas as a multiple of the heat that would be absorbed by the same mass of carbon dioxide) may be determined. The total carbon dioxide equivalent may then be used to express an environmental impact measure or value, e.g., a global warming potential. This may be similarly done for other environmental impacts, e.g., fossil fuel usage.

As mentioned, each or any of the lighting devices may be configured to store and additionally actively maintain the data (e.g., inventory data of an LCA). Data may be obtained and added to any existing stored data or may be used to update or maintain any existing stored data at or during any of the different lifetime stages (1) to (5) as mentioned in the foregoing, especially at or during any of the stages (1) to (4).

For example, at lifetime stages (1) and (2), data, e.g., in the form of the LCA data file, may be uploaded to the lighting device (e.g., to a memory thereof) during the production stage of the lighting device, or optionally at the start of the use of the lighting device. The data, e.g., the LCA data file, will then represent the resource usage (inputs and outputs) related to the raw material extraction stage, and the processing (e.g., manufacturing) stage. The resources required during the raw material extraction and processing stages of the lighting device are generally known by the manufacturer. Hence, the manufacturer may store a pre-filled LCA data file with the inventory data for the stages (1) and (2) in the lighting device or may update the inventory data of an existing (e.g., empty) LCA data file already present in the lighting device. This may occur at the end of the processing stage (e.g., when the lighting device is leaving the factory). According to another example, the inventory data related to the raw materials extraction and processing stages may be stored, or updated, by a network entity such as backend server of the manufacturer, for example if and when the lighting device becomes connected to the network entity for the first time. The lighting device may be associated with a unique identifier that may enable the network entity such as the backend server to transmit the corresponding data to the lighting device (e.g., similarly to a firmware update).

For example, at stage (3), the lighting device may subsequently be distributed and transported to a customer. For example at installation of the lighting device, the LCA data file may be updated with the resource usage during the transportation phase, which updating may depend on for example whether the lighting device is distributed by means of e-truck or a gasoline truck, whether the lighting device is transported by train or by ship, what happens to the packaging of the lighting device after its installation, whether additional resources are required to install the lighting device (e.g., glue, aluminum rails, etc.) or not, etc. The resource usage during installation may be estimated or may be actively monitored by, e.g., a person that installs the lighting device, in which case that person may update the LCA data file in the lighting device accordingly. For example, the lighting device may transmit its serial number and/or geographical location to a network entity such as a backend server of the manufacturer, and the network entity may return the resource usage during transportation known for the serial number and/or and optionally an estimated resource usage during transportation between the last known location of the lighting device (e.g., distribution center) and the geographical location of the lighting device. According to another example, the person that installs the lighting device may update the LCA data file with the resource usage during the transportation phase. The person that installs the lighting device may thereby have a predefined estimation of the resource usage during the transportation phase. Possibly, the manufacturer may provide the person that installs the lighting device with a questionary to fill in, such that the resource usage during the transportation stage can be accounted for and automatically calculated by estimation. The questions in the questionary may for example relate to the distance driven to the deliver the lighting device to its recipient, whether the vehicle used for delivering the lighting device is electrically powered, etc. Possibly, a part of the resource usage during the transportation stage may be retrieved from a tracking database of any distributors which may be used, such as DHL or United Parcel Service (UPS).

For example, during stage (4), i.e., during the use stage, the data file stored in the lighting device may be continuously updated. The data obtained during the use stage may be dominated by the energy consumption (fossil or green) of the lighting device. The lighting device may be able to measure its own energy usage.

Each or any of the lighting devices may be configured such that the data stored in the lighting device may be accessed or retrieved at any time, e.g., by an owner of the lighting device in the use stage, or by a manufacturer of the lighting device in the raw material extraction and/or processing stages.

The controller may be configured to obtain, for each of the lighting device, information on whether the lighting device is currently powered by electrical energy based on renewable energy sources or by electrical energy based on non-renewable energy sources.

For example, an entity which may update the LCA data file of each or any of the lighting devices, e.g., during the use stage, may have access to such information, and may include the information in the LCA data file of the lighting device(s). In that way, a more accurate environmental impact may be determined when converting the LCA (inventory) data into an environmental impact. For example, consumption of energy derived from solar or wind based energy sources may have a different impact on global warming (potential) and/or abiotic resource depletion that consumption of energy from coal or gas based energy sources.

Optionally, for the lighting device, at least one of data for at least one resource usage or a measure of at least one (potential) environmental impact of the lighting device derived from the stored data of the lighting device is determined (e.g., by the controller), and then, operation of the lighting device is controlled (e.g., by the controller) based on the value of the data for at least one resource usage and/or the measures of the at least one (potential) environmental impact determined for the lighting device. Thus, according to one or more embodiments of the present invention, the operation of the plurality of lighting devices can be controlled in dependence on the (e.g., estimated) environmental impact of the respective lighting devices, as determined by means of one or more LCA methodologies.

A plurality of lighting devices may be controlled (e.g., by the controller) such that any of the plurality of lighting devices having a value representative of the at least one resource usage and/or the at least one (potential) environmental impact that exceeds a threshold value is not operated and such that the other one(s) of the plurality of lighting devices are operated. The threshold value may represent a value of a measure of at least one resource usage and/or at least one (potential) environmental impact of the lighting devices chosen such that if the value is exceeded for a lighting device, the lighting devices is not considered to be environmentally sustainable. The other one(s) of the plurality of lighting devices may be controlled as a group, such that operation of each of the other one(s) of the plurality of lighting devices is controlled in the same way. In the context of the present application, by controlling lighting devices in the same way, it may be meant that the lighting devices are operated to provide the same lighting function or functionality, for example such that lighting devices in the form of Hue lamps provide the same function of ambient lighting. Further, by controlling lighting devices in the same way, it may be meant that each of the lighting devices is controlled so as to achieve the same or substantially the same overall light effect (which may be referred to as a light scene). Therefore, to control lighting devices in the same way may not necessarily entail that all lighting devices are controlled so as to emit light having the same characteristics such as intensity, color, dynamics, etc. (but it could be). The lighting devices could be controlled to emit light having different characteristics while still achieving the same or substantially the same overall light effect. For example, in entertainment lighting, different lamps may be caused to emit light with different characteristics based on the spatial positions of the lamps, but the overall effect may be the same (e.g., a sunset scene).

Each or any of the plurality of lighting devices may be configured to, when operated, selectively provide one or more lighting functionalities. The plurality of lighting devices may be controlled (e.g., by the controller) such that only any of the plurality of lighting devices having a value representative of the at least one resource usage and/or the at least one (potential) environmental impact that does not exceed a threshold value is operated to provide one or more of the lighting functionalities of the lighting devices. Thereby, the other one(s) of the plurality of lighting devices having a value representative of the at least one resource usage and/or the at least one potential environmental impact that exceeds a threshold value may not be operated to provide one or more of the lighting functionalities of the lighting devices. As before, the threshold value may represent a value of a measure of at least one resource usage and/or at least one (potential) environmental impact of the lighting devices chosen such that if the value is exceeded for a lighting device, the lighting devices is not considered to be environmentally sustainable. In that way, a user of the plurality of lighting devices may be encouraged to not utilize any one of lighting devices that is not considered to be environmentally sustainable, by that lighting device being unable to provide one or more of the lighting functionalities.

As mentioned, each or any of the lighting devices may be configured to, when operated, selectively provide one or more lighting functionalities. An average value or a sum of the values representative of the at least one resource usage and/or the at least one (potential) environmental impact determined for the respective ones of the lighting devices may be determined (e.g., by the controller). The plurality of lighting devices may be controlled (e.g., by the controller) such that they are not operated, or such that one or more selected lighting functionalities of the lighting devices are prevented from being used during operation of the lighting devices, or such that one or more selected lighting functionalities of the lighting devices are degraded during operation of the lighting devices, if the average value or sum exceeds a threshold value. As before, the threshold value may represent a value of a measure of at least one resource usage and/or at least one (potential) environmental impact of the lighting devices chosen such that if the value is exceeded for a lighting device, the lighting devices Is not considered to be environmentally sustainable.

By controlling a lighting device such that such that one or more selected lighting functionalities of the lighting device is degraded or even prevented from being used during operation of the lighting device if the average value or sum exceeds the threshold value, a user of the lighting device is encouraged to not utilize a lighting device if it is not an environmentally sustainable lighting device. For example, the maximum intensity of the light emitted by the lighting device and/or operating power of the lighting device may be restricted if the average value or sum exceeds the threshold value.

An average value or a sum of the values representative of the at least one resource usage and/or the at least one (potential) environmental impact which have been determined for the respective ones of the lighting devices may be determined (e.g., by the controller). If the average value or sum does not exceed a threshold value, the plurality of lighting devices may be controlled (e.g., by the controller) as a group, such that operation of each of the plurality of lighting devices is controlled in the same way. If the average value or sum exceeds the threshold value, the plurality of lighting devices may be controlled (e.g., by the controller) individually, and not as a group. In this way, it may be achieved that only if the plurality of lighting devices, as a group, are considered to environmentally sustainable, they are controlled as a group—in the same way—and otherwise each of the plurality of lighting devices is be controlled individually. This may ensure that only lighting devices considered to environmentally sustainable can be controlled in a group, or that the group of lighting devices itself meets a requirement for environmental sustainability, or to encourage environmentally unsustainable lighting devices to not be controlled as a group. As before, the threshold value may represent a value of a measure of at least one resource usage and/or at least one (potential) environmental impact of the lighting devices chosen such that if the value is exceeded for a lighting device, the lighting devices is not considered to be environmentally sustainable.

For each of the lighting device, information on whether the lighting device is currently powered by electrical energy based on renewable energy sources (which may be referred to a ‘green energy’) or by electrical energy based on non-renewable energy sources (which may be referred to a ‘grey energy’) may be obtained. Such information may for example be obtained by the controller. Accordingly, the controller may be configured to obtain such information. The plurality of lighting devices may be controlled (e.g., by the controller) such that any lighting device(s) having a value representative of the at least one resource usage and/or the at least one (potential) environmental impact that is exceeding a threshold value is operated only if the lighting device(s) is currently powered by electrical energy based on renewable energy sources, and such that any lighting device(s) having a value representative of the at least one resource usage and/or the at least one (potential) environmental impact that is not exceeding the threshold value is operated if the lighting device(s) is currently powered by electrical energy based on non-renewable energy sources. As before, the threshold value may represent a value of a measure of at least one resource usage and/or at least one (potential) environmental impact of the lighting devices chosen such that if the value is exceeded for a lighting device, the lighting devices is not considered to be environmentally sustainable. In this way, lighting device(s) considered to be environmentally sustainable may be operated (e.g., only) if it is currently powered by electrical energy based on non-renewable energy sources, and lighting device(s) considered to environmentally unsustainable (or at least less environmentally sustainable) may be operated (e.g., only) if it is currently powered by electrical energy based on renewable energy sources. In that way, less environmentally sustainable lighting devices and more environmentally sustainable lighting devices can be brought closer together with respect to their environmental impact.

According to one implementation example, the controller may for each of the plurality of lighting devices determine whether the lighting device is currently powered by green energy or by grey energy, and control only that or those lighting devices having a measure or value of at least one (potential) environmental impact that is not exceeding a threshold (value) to provide a lighting functionality if it or they are currently powered by grey energy, and control only that or those lighting devices having a measure or value of at least one (potential) environmental impact that is exceeding a (or the) threshold (value) to provide a lighting functionality if it or they are currently powered by green energy. Thereby, less environmentally sustainable lighting devices and more environmentally sustainable lighting devices can be brought closer together with respect to their environmental impact.

The controller is configured to store second data in the memory during the lifetime of the lighting device after the manufacturing of the lighting device is completed. The controller may be configured to obtain, for each of the lighting device, a value representative of an emission intensity of the electrical energy by which the lighting device is currently powered. The value representative of an emission intensity of the electrical energy by which the lighting device is currently powered may for example be a value representative of carbon intensity of the electrical energy by which the lighting device is currently powered, and may for example be constituted by the carbon intensity per kilowatt-hour or some similar quantity. The controller may for example be configured to obtain (e.g., receive or retrieve) the value representative of an emission intensity of the electrical energy by which the lighting device is currently powered from some entity which provides estimations of the emission intensity (e.g., carbon intensity) of electricity consumed in an electrical power system across different regions of the country in which the lighting device is used. The controller may be configured to control the plurality of lighting devices such that any lighting device(s) having a value representative of the at least one resource usage and/or the at least one (potential) environmental impact that is exceeding a threshold value is operated only if the value of the emission intensity of the electrical energy by which the lighting device(s) is currently powered is not exceeding a threshold emission intensity value, and such that any lighting device(s) having a value representative of the at least one resource usage and/or the at least one (potential) environmental impact that is not exceeding the threshold value is operated if the value of the emission intensity of the electrical energy by which the lighting device(s) is currently powered exceeds the threshold emission intensity value. As before, the threshold value may represent a value of a measure of at least one resource usage and/or at least one (potential) environmental impact of the lighting devices chosen such that if the value is exceeded for a lighting device, the lighting devices is not considered to be environmentally sustainable.

As mentioned, for each of the lighting devices, at least one of a measure of at least one resource usage or a measure of at least one (potential) environmental impact of the lighting device derived from the stored data of the lighting device may be determined (e.g., by the controller). The determination of the (currently accrued) measure of at least one (potential) environmental impact of the lighting devices may be done in several ways.

For example, for each of the lighting devices, a value of the at least one (potential) environmental impact of the lighting device may for example be determined (e.g., by the controller) in the following way. For each of the lighting devices, the stored data of the lighting device may be obtained (e.g., received or retrieved), and the value of the at least one (potential) environmental impact of the lighting device may be determined based on data indicative of one or more natural resources usage in the stored data of the lighting device.

Thus, according to one example, the controller may obtain the stored data (e.g., including an inventory table with a list of resource usage) from each of the lighting devices, and then determine (e.g., calculate) the value of the at least one (potential) environmental impact of the lighting device based on the data.

Thus, according to one implementation example, the controller may obtain (or read, determine, or poll) the stored data file of each lighting device of the plurality of lighting devices. As mentioned, the data file may be indicative of the resource usage related to the lighting device during the respective stages of the lifecycle of the lighting device, and the data file may comprise a list of resources and a plurality of entries, each defining a resource usage of a listed resource during a lifecycle of the lighting device. The controller may then transform the resource usage of the lighting device during the respective stages of the lifecycle of the lighting device into a measure of at least one (potential) environmental impact of the lighting device (e.g., based on LCA methodologies). In this way, it may for example be determined that a first lighting device of a plurality of lighting devices has a Global Warming Potential X, a second lighting device of the plurality of lighting devices has a Global Warming Potential Y, a third lighting device of the plurality of lighting devices has a Global Warming Potential Z, etc., where X, Y, and Z may be values representative of global warming potential.

In alternative or in addition, the value of the at least one (potential) environmental impact of each of the lighting devices may be determined by the respective ones of the lighting devices. Each lighting device may be configured to determine a value of the at least one (potential) environmental impact of the lighting device based on data indicative of one or more natural resources usage in the stored data of the lighting device.

The controller may be configured to determine, for each of the lighting devices, a value of the at least one (potential) environmental impact of the lighting device by, for each of the lighting devices, obtaining (e.g., receiving or retrieving) the measure of the at least one (potential) environmental impact of the lighting device having been determined by the lighting device.

Thus, according to one implementation example, the stored data file in a memory of a lighting device is indicative of the resource usage related to the lighting device during the respective stages of the lifecycle of the lighting device, and the data file may comprise a list of resources and a plurality of entries, each defining a resource usage of a listed resource during a respective stage of the lifecycle of the lighting device. The lighting device may transform the resource usage of the lighting device during the respective stages of the lifecycle of the lighting device into a measure of at least one (potential) environmental impact of the lighting device (e.g., based on LCA methodologies). The controller may then for the lighting device, obtain (or read, or determine) the value of the at least one (potential) environmental impact of the lighting device having already been determined ‘locally’ by the lighting device.

For the lighting device, the value of the at least one (potential) environmental impact of each of the lighting device may be determined (e.g., by the controller or by the lighting device itself) based on data indicative of one or more natural resources usage in the stored data of the lighting device for example by means of an LCA method.

The at least one (potential) environmental impact may for example include or be constituted by one or more of global warming (potential) or natural resources depletion, such as abiotic depletion.

The controller may for example comprise a user interface or be constituted by a user interface device. The controller may be configured to obtain (e.g., receive or retrieve) an indication of a threshold value such as described in the foregoing. For example, any user interface of the controller may be configured to receive use input indicating the threshold value.

According to one or more other example embodiments of the present invention, the lighting device or the lighting system may comprise a user interface device, which may comprise the controller and some means for providing information or indications to a user, e.g., a display to provide visual indications or feedback. Means for providing other types of indications or feedback, such as audible, are however possible. The measures of at least one resource usage and/or the measures of at least one (potential) environmental impact of the lighting device derived from the stored data of the respective ones of the lighting devices, e.g., the values representative of the at least one resource usage and/or the at least one (potential) environmental impact, respectively, may be presented to the user via the display. The controller may be configured to determine a suggestion to the user for how to control the plurality of lighting devices based on the determined measures or values and indicate the suggestion to the user via the display. For example, if any of the determined measures or values exceeds a predefined threshold (value), the controller may be configured to generate an alert to the user, e.g., a visual alert via the display, and/or a suggestion to the user for how to control the plurality of lighting devices. The controller may be configured to aggregate the determined measures or values and indicate an aggregated measure or value of at least one (potential) environmental impact to the user via the display.

The controller may be connected with each of the plurality of lighting devices. For example, each or any of the plurality of lighting devices may comprise a processor that is configured to store (and optionally obtain) the data. In aspects, a master lighting device of the plurality of lighting devices may comprise the controller. For each or any of the plurality of lighting devices, the data may for example be stored in the lighting device, such as, for example, in a memory which may be comprised in the lighting device. In alternative or in addition, for each or any of the plurality of lighting devices, the data could be stored in some other entity accessible by the lighting device and/or the controller, e.g., in an entity included in a communications network which the lighting device(s) and/or the controller may be connected to.

The light source of the lighting device may for example comprise or be constituted by one of more solid-state light sources, such as one or more light emitting diodes (LEDs), one or more superluminescent LEDs or one or more laser diodes.

The controller may for example comprise one or more processors, control units, control devices, etc., each or any of which for example may include or be constituted by any suitable central processing unit (CPU), microcontroller, digital signal processor (DSP), Application Specific Integrated Circuit (ASIC), Field Programmable Gate Array (FPGA), etc., or any combination thereof. The controller or one or more control units, control devices, etc., may optionally be capable of executing software instructions stored in a computer program product, e.g., in the form of a memory. The memory may for example be any combination of read and write memory (RAM) and read only memory (ROM). The memory may comprise persistent storage, which for example can be a magnetic memory, an optical memory, a solid state memory or a remotely mounted memory, or any combination thereof.

The controller or one or more control units, control devices, etc., may for example comprise driver circuitry (e.g., LED driving circuitry) for controlling supply of power to the respective ones of the lighting devices and/or for controlling operation of the respective ones of the lighting devices. The driver circuitry may for example comprise driver circuitry configured to drive (or control operation of) the respective ones of the lighting device. The controller or one or more controllers, control units, control devices, etc., may be configured to control operation of the respective ones of the lighting devices for example by way of transmitting at least one control signal or control message or the like to the respective ones of the lighting devices.

An advantage of an embodiment of the lighting device according to claim 2, is that the first data do not have to be stored in each individual lamp, but can be centrally stored. This configuration also allows an easier update of the first data, if necessary.

An advantage of an embodiment of the lighting device according to claim 3 is that by using the geographical location where the lighting device has been installed, the distance for transportation of the lighting device from the manufacturing site to the installation site of the lighting device can be relatively easy determined. The lighting device may comprise a GPS receiver for determining the geographical location, wherein the controller may be configured to determine said geographical location via said GPS receiver. Alternatively, the lighting device may comprise a receiver for receiving a user input indicative of the geographical location, wherein the controller is configured to determine said geographical based on said received user input.

An advantage of an embodiment of the lighting device according to claim 4 is that such an interface allows a user to retrieve the first and/or second data for review and analysis.

An advantage of an embodiment of the lighting device according to claim 5 is that it allows keeping track of the use of resources and environmental impact during operation of the lighting device during its use.

An advantage of an embodiment of the lighting device according to claim 6 is that it allows to keep in more detail track of which type of resources and how much thereof is used.

An advantage of an embodiment of the lighting device according to claim 7 is that it allows to keep real-time track of the electricity usage of the lighting device.

An advantage of an embodiments of the lighting devices according to claims 8 and 9 is that determining the impact value for at least one impact category allows a relatively easy comparison between different light sources of their respective environmental impact.

An advantage of an embodiment of the lighting device according to claim 10 is that it allows to make a more detailed assessment of usage of various resources required for manufacturing of the lighting device.

An advantage of an embodiment of the lighting device according to claim 12 is that it allows to keep track of the environmental impact of the lighting device during its various lifetime stages.

In aspects, the lighting system is selected from the group of a lamp, a luminaire, a projector device, a disinfection device, a photochemical reactor, an automotive lighting device, and an optical wireless communication device, comprising the lighting device according to the present invention. Optionally, the lighting system comprises a user interface and/or a sensor. The user interface may comprise a controller and some means for providing information or indications to a user, e.g., a display to provide visual indications or feedback. The sensor may sense the light intensity, light spectrum or presence of the people, and generate a sensor signal. The controller may control the lighting device depending on the sensor signal.

In aspects, the invention may provide a system comprising: a plurality of electronic devices; and a controller configured to control operation of the respective ones of the plurality of electronic devices; each electronic device being configured to obtain and store data indicative of at least one of one or more natural resources usage or one or more (potential) environmental impacts which is caused by operations carried out in relation to the electronic device from its manufacture and during the lifetime thereof; the controller being configured to: determine, for each of the electronic devices, at least one of a measure of at least one resource usage or a measure of at least one (potential) environmental impact of the electronic device derived from the stored data of the electronic device; and control operation of at least one of the plurality of electronic devices based on the measures of the at least one resource usage and/or the measures of the at least one (potential) environmental impact determined for the respective ones of the electronic devices. Thus, principles of one or more embodiments of the present invention may be applicable not only to systems comprising a plurality of lighting devices, but may apply similarly or the same as described herein to systems comprising one or more types of electronic devices other than lighting devices.

Further objects and advantages of the present invention are described in the following by means of exemplifying embodiments. Further features of, and advantages with, the present invention will become apparent when studying the appended claims and the description herein.

In aspects, the lighting device may comprise an input interface for conveying a first input to the controller, wherein the first input comprises the first data. The input interface may comprise a receiver for receiving said first input. The controller may be configured to receive or retrieve said first input from the input interface. The controller may determine (or: obtain) the first data based on said first input. The first input may comprise a predetermined data format. The predetermined data format may be associated with a particular LCA methodology and/or with a inventory table of a particular LCA methodology. The memory according to the invention may be configured to only store the first data if a received or retrieved first input comprises the predetermined data format. The controller may be configured to check whether a first input comprises the predetermined data format, and only store the first data in the memory if the first input comprises the predetermined data format.

In aspects, said input interface may be arranged for conveying a second input to the controller, wherein the second input comprises the second data. The input interface may comprise a receiver for receiving said second input. The controller may be configured to receive or retrieve said second input from the input interface. The controller may determine (or: obtain) the second data based on said second input. The second input may comprise said predetermined data format. Hence, the first input and the second input may comprise the same predetermined data format. As mentioned, the predetermined data format may be associated with a particular LCA methodology and/or with a inventory table of a particular LCA methodology. The memory according to the invention may be configured to only store the second data if a received or retrieved second input comprises the predetermined data format. The controller may be configured to check whether a second input comprises the predetermined data format, and only store the second data in the memory if the second input comprises the predetermined data format.

In further aspects of the invention, phrased differently, the invention provides: a lighting device comprising a light source, controller, and a memory; wherein the controller is configured to store a data file in the memory during at least a first (temporal) stage associated with the (product) lifecycle of the lighting device; wherein the controller is configured to update the stored data file during at least a second (temporal) stage associated with the (product) lifecycle of the lighting device; wherein the data file is indicative of the resource usage the lighting device during the respective (temporal) stages of the (product) lifecycle of the lighting device. In aspects, the data file comprises a list of resources and a plurality of entries, each defining a resource usage of a listed resource during a (product) lifecycle of the lighting device. In aspects, the lighting device is a LED luminaire or a LED bulb. In aspects, said updating the stored data file may comprise adding new data to initial data of the stored data file without changing the initial data, i.e. preventing the initial data to be changed. In more aspects, the controller may be configured to obtain (retrieve or receive) data from a backend server or an external device and update the stored data file with said data during at least the second (temporal) stage associated with the (product) lifecycle of the lighting device. In more aspects, the controller may be configured to determine a geographical location of the lighting device, wherein the controller is configured to obtain (retrieve or receive) data associated with said geographical location from a backend server or an external device, and update the stored data file with said data during at least a second (temporal) stage of the (product) lifecycle of the lighting device. In more aspects, the controller may be configured to obtain a unique identifier of the lighting device, wherein the controller is configured to obtain (retrieve or receive) data associated with said unique identifier from a backend server or an external device, and update the stored data file with said data during at least a second (temporal) stage of the (product) lifecycle of the lighting device. In more aspects, the lighting device further comprises an output interface, wherein the output interface is configured to convey (i.e. transmit, forward, make accessible) the data file to a reader device. In more aspects, the second (temporal) stage of the (product) lifecycle of the lighting device is a use stage of the lighting device; wherein the controller is configured to update the stored data file during at least said use stage of the (product) lifecycle of the lighting device; wherein the data file comprises a list of resources and a plurality of entries, each defining a resource usage of a listed resource during a lifecycle of the lighting device. For example, a first listed resource of the list of resources may be electricity. In more aspects, the controller may be configured to determine an actual electricity usage of the lighting device; wherein the controller is configured to update the stored data file during at least said use stage of the (product) lifecycle of the lighting device by updating the resource usage of electricity with said actual electricity usage. In more aspects, the memory may be configured to store a predetermined transformation function, wherein the controller is configured to apply the predetermined transformation function to the data file and transform the resource usage of the lighting device during the respective (temporal) stages of the (product) lifecycle of the lighting device into an environmental impact value for at least one impact category. Such transformation function may be predefined. Such transformation function may be associated with a known LCA method. In more aspects, the predetermined transformation function may be configured to first transform the resource usage of the lighting device during the respective (temporal) stages of the (product) lifecycle of the lighting device into the resource usage of the lighting device during the respective stages of the (product) lifecycle of the lighting device in terms of an equivalent unit, and subsequently transform the resource usage of the lighting device during the respective (temporal) stages of the (product) lifecycle of the lighting device in terms of the equivalent unit into an environmental impact value for at least one impact category. In more aspects, the controller may further be configured to determine a respective condition in which a respective resource usage and/or environmental impact value exceeds a predefined threshold value, and convey a signal if said condition is determined. Said signal may be an alert signal and/or a notification signal and/or a control signal, such as for example a lighting control signal controlling the light source of the lighting device to emit light having a predefined color.

### BRIEF DESCRIPTION OF THE DRAWINGS

Exemplifying embodiments of the invention will be described below with reference to the accompanying drawings.

FIG. 1 is a schematic view of a lighting device according to an embodiment of the present invention.

FIG. 2 is a schematic view of a lighting device according to an embodiment of the present invention.

FIG. 3 is a schematic flowchart of a method according to an embodiment of the present invention.

FIG. 4 is a schematic view of embodiments of a lighting system of the present invention.

All the figures are schematic, not necessarily to scale, and generally only show parts which are necessary in order to elucidate embodiments of the present invention, wherein other parts may be omitted or merely suggested.

### DESCRIPTION WITH REFERENCE TO THE DRAWINGS

The present invention will now be described hereinafter with reference to the accompanying drawings, in which exemplifying embodiments of the present invention are shown. The present invention may, however, be embodied in many different forms and should not be construed as limited to the embodiments of the present invention set forth herein; rather, these embodiments of the present invention are provided by way of example so that this disclosure will convey the scope of the invention to those skilled in the art. In the drawings, identical reference numerals denote the same or similar components having a same or similar function, unless specifically stated otherwise.

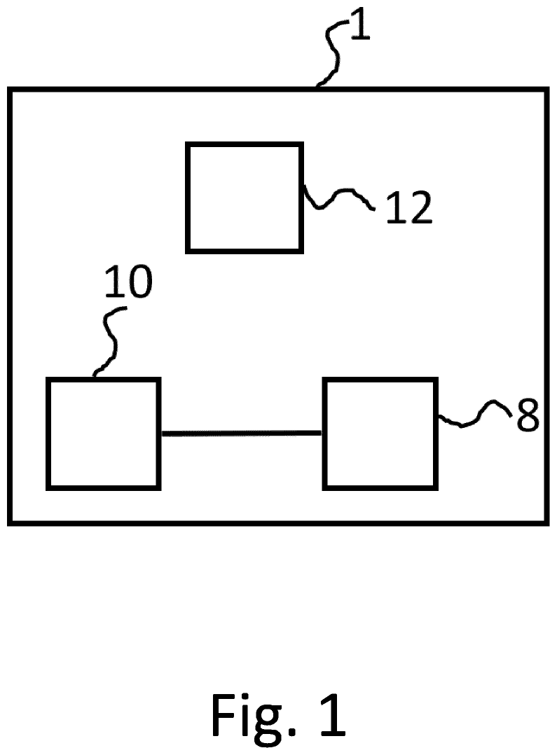

FIG. 1 is a schematic view of a lighting device 1 according to an embodiment of the present invention. The lighting device 1 comprises a light source 12 configured to generate light, a memory 10 configured to store data and a controller 8. The light source 12 may alternatively be configured to perform sensing of its surrounding space. For example, operating an integrated camera or radar sensing in the lighting device may cost relatively more energy, hence may have an additional impact on resource use and/or environmental impact. In embodiments, light source 12 comprises one or more solid-state light sources, such as one or more (superluminescent) light emitting diodes or laser diodes.

Controller 8 is configured to store first data in the memory 10. The first data are indicative of at least one of one or more (natural) resources usage or one or more potential environmental impacts which is caused by operations carried out in relation to manufacturing, which may include raw material extraction, of the lighting device. These resources may be raw materials used in the manufacturing of the lighting device 1, such as for example metals and polymer materials, and electricity used during the manufacturing process. Such (natural) resource usage may also comprise the use of glue, wood, water, heat, etc. during the manufacturing process.

The first data may be obtained by the controller 8 in the factory during the manufacturing process. Alternatively, the lighting device 1 may have a unique identifier and the controller 8 retrieves the first data from a remote database using the first identifier.

Controller 8 is further configured to prevent adjusting the first data stored in the memory, preferably after the manufacturing of the lighting device has been completed. By preventing adjusting the first data at some point time it is prevented that these data are erroneously or purposively changed, which would result in unreliable LCA data. By preventing adjusting the data after the manufacturing process, the reliability of the LCA data related to that stage of the lifetime of the lighting device 1 is guaranteed.

In aspects, the controller may be configured to prevent adjusting the first data stored in the memory after the first power-on of the lighting device. Hence, when the lighting device is taken in use, the first data cannot be adjusted anymore, as the manufacturing stage of the lifecycle of the lighting device is completed.

Controller 8 is further configured to store second data in the memory 10. The second data are indicative of at least one of one or more (natural) resources usage or one or more potential environmental impacts which is caused by operations carried out in relation to the lighting device during the lifetime thereof after the manufacturing has been completed. In embodiments, the second data relate to one or more stages of the lifetime of the lighting device 1 related to use and disposal at end of life (e.g. recycling) of the lighting device 1. In an embodiment the second date relate to use of the lighting device 1.

In another embodiment, the controller 8 is further configured to store third data in the memory 10. The third data are indicative of at least one of one or more (natural) resources usage or one or more potential environmental impacts which is caused by operations carried out in relation to the lighting device during the disposal at end of life of the lighting device.

In an embodiment, the lighting device comprises an output interface via which the first data and/or the second data can be conveyed to a user interface, allowing a user to have insight in these first and/or second data (and/or third data if available)In an embodiment, the first data comprises a comprise a data file comprising a list of resources and a plurality of entries therefore. This (predefined) list of resources may comprise one or more types of electrical components, on or more types of mechanical components, one or more types of optical components, one or more different metals, one or more different inorganic materials and one or more different polymer materials. In an embodiment, the controller is further configured to determine a geographical location of the lighting device and to obtain a geographical location of the production location of the lighting device. Based on these geographical locations, the controller may determine second data related to the transportation of the lighting device. In an embodiment, the controller obtains data related to the type of transportation that has been used, using a unique identifier of the lighting device 1, from a remote database. In an embodiment, the memory 8 of the lighting device 1 is configured to store a predetermined transformation function and the controller is configured to apply the predetermined transformation function to convert the first data and second data stored in the memory 10 into an environmental impact value for at least one impact category. In an embodiment, the predetermined transformation function is configured to first convert the resource usage of the lighting device 1 according to the first data and the second data, respectively, into the resource usage of the lighting device in terms of an equivalent unit, and subsequently convert the resource usage of the lighting device 1 according to the first and second data, respectively, in terms of the equivalent unit into an environmental impact value for at least one impact category.

The first data may be retrieved or received by the controller in predefined data format.

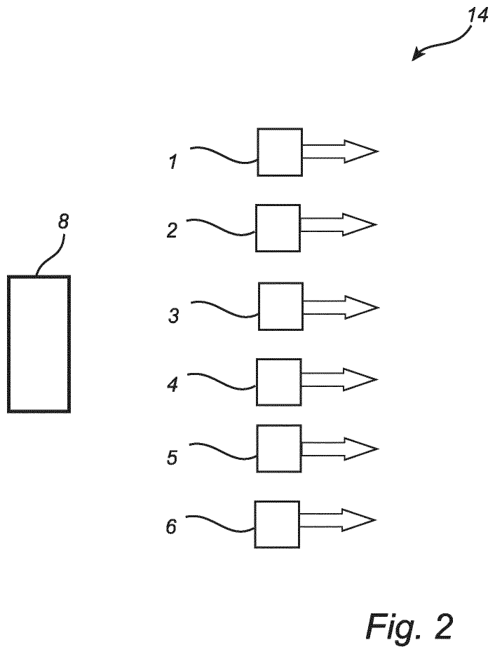

FIG. 2 is a schematic view of a plurality of lighting devices 14 according to an embodiment of the present invention.

The plurality of lighting devices 14 comprises lighting devices 1 to 6. It is to be understood that the number of lighting devices illustrated in FIG. 2 is exemplifying other embodiments could comprise fewer or more lighting devices than illustrated in FIG. 2.

Each of the lighting devices 1-6 may be configured to emit light, schematically indicated by the arrows in FIG. 2. Each of the lighting devices 1-6 may be controllable with respect to operation thereof, for example with respect to one or more characteristics of the emitted light, such as, for example with respect to the light spectrum of the emitted light. To that end, each or any of the lighting devices 1-6 could for example comprise at least one wavelength variable light source (not shown in FIG. 1) that may be controllable at least with respect to the wavelength of the light emitted by the at least one wavelength variable light source. In alternative or in addition, each of the lighting devices 1-6 may be controllable with respect to other characteristics of the operation thereof, such as intensity of the emitted light, operating power, etc.

The plurality of lighting devices 14 comprises a controller 8, which may be configured to control operation of the respective ones of the plurality of lighting devices 1-6. Although FIG. 2 indicates a wireless connection between the controller 8 and the lighting devices 1-6, it is to be understood that the controller 8 and the lighting devices 1-6 may be connected via one or more wired connections and/or one or more wireless connections, e.g., by way of any appropriate wired and/or wireless connections as known in the art. The controller 8 may be configured to control operation of the respective ones of the lighting devices 1-6 for example by way of transmitting at least one control signal or control message or the like to the respective ones of the lighting devices 1-6.

As has been described herein, each of lighting devices 1-6 may be configured to store (and optionally obtain) first and second data indicative of at least one of one or more natural resources usage or one or more potential environmental impacts which is caused by operations carried out in relation to the lighting device 1-6 from its manufacture and during the lifetime thereof. Controller 8 is further configured to prevent adjusting the first data stored in the memory, preferably after the manufacturing of the lighting device has been completed. For each or any of the plurality of lighting devices 1-6, the first and second data indicative of at least one of one or more natural resources usage or one or more potential environmental impacts which is caused by operations carried out in relation to the lighting device 1-6 from its manufacture and during the lifetime thereof may for example relate to at least one of manufacturing, shipping, storage, installation, use or disposal of the lighting device 1-6. As has been described herein, the first and second data may be obtained from different entities involved in operations carried out in relation to the respective lighting devices 1-6 from their manufacture and during the lifetime thereof, such as different entities (not shown in FIG. 2) involved in the manufacturing, shipping, storage, installation, use and/or disposal of the respective lighting devices 1-6.

The controller 8 may be configured to determine, for each of the lighting devices 1-6, at least one of a measure of at least one resource usage or a measure of at least one potential environmental impact of the lighting device 1-6 derived from the stored first and second data of the lighting device 1-6. For each lighting device 1-6, the measure of at least one potential environmental impact of the lighting device 1-6 may be derived from data indicative of one or more natural resources usage in the stored data of the lighting device 1-6 for example by means of a life cycle assessment method. The controller 8 may be configured to control operation of at least one of the plurality of lighting devices 1-6 based on the measures of the at least one resource usage and/or the measures of the at least one potential environmental impact determined for the respective ones of the lighting devices 1-6.

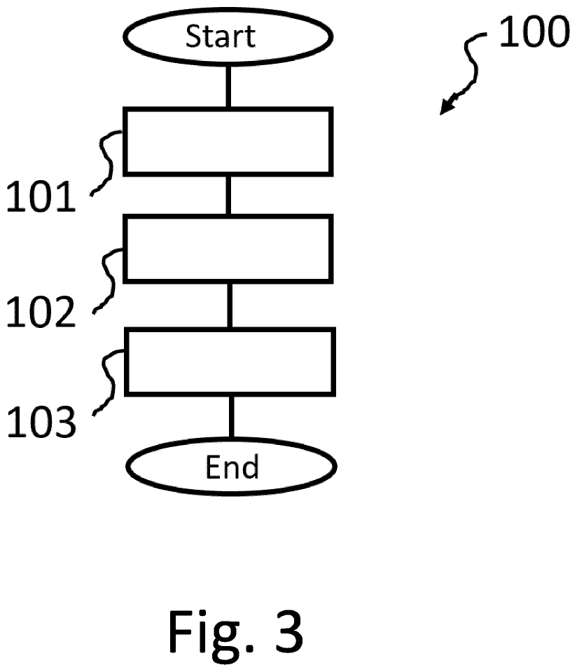

FIG. 3 is a schematic flowchart of a method 100 according to an embodiment of the present invention. The method 100 is carried out in or in relation to a one or more lighting device, wherein each lighting device is configured to store data indicative of at least one of one or more natural resources usage or one or more potential environmental impacts which is caused by operations carried out in relation to the lighting device from its manufacture and during the lifetime thereof. The method 100 comprises, at 101, storing first data in the memory 10, the first data being indicative of at least one of one or more (natural) resources usage or one or more potential environmental impacts which is caused by operations carried out in relation to manufacturing of the lighting device. The method further comprises, at step 102, preventing adjusting the first data stored in the memory, preferably after the manufacturing of the lighting device has been completed. The method further comprises, in step 103, storing second data in the memory 10, the second data being indicative of at least one of one or more natural resources usage or one or more potential environmental impacts which is caused by operations carried out in relation to the lighting device during the lifetime thereof after the manufacturing has been completed. The method 100 may then end.

According to an embodiment of the invention, a computer program product comprises instructions which, when executed by at least one processor of a controller 8 of a lighting device 10 according to FIG. 1 or 2, cause the controller to carry out a method 100 according to FIG. 3.

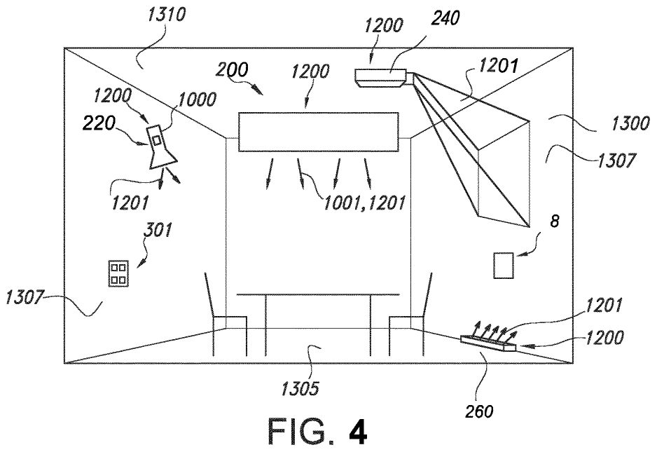

FIG. 4 is a schematic view of embodiments of the lighting system 1200 according to embodiments of the present invention. A luminaire 200 comprises the lighting device of the present invention. Reference 301 indicates a user interface which may be functionally coupled with the controller 8 comprised by or functionally coupled to the lighting device of the luminaire 200. FIG. 2 also schematically depicts an embodiment of lamp 220 comprising the lighting device of the present invention. Reference 301 indicates a user interface which may be functionally coupled with the controller 8 comprised by or functionally coupled to the lighting device of the lamp 220. Reference 240 indicates a projector device or projector system, which may be used to project images, such as at a wall, which may also comprise the lighting device of the present invention. Reference 301 indicates a user interface which may be functionally coupled with the controller 8 comprised by or functionally coupled to the lighting device of the projector 240. Hence, FIG. 4 schematically depicts embodiments of a lighting system 1200 selected from the group of a lamp 220, a luminaire 200, a projector device 240, a disinfection device 260, a photochemical reactor (not shown), an automotive lighting device (not shown) and an optical wireless communication device 260, comprising the lighting device of the present invention. Light escaping from the lighting system 1200 is indicated with reference 1201. Reference 1300 refers to a space, such as a room. Reference 1305 refers to a floor and reference 1310 to a ceiling; reference 1307 refers to a wall. In an embodiment, lamp 220 comprises a socket for receiving energy for operation of the lamp. Optionally, the socket may also be used for mechanical fixation of the lamp in a luminaire or in another type of system.

While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A lighting device comprising:
a light source configured to generate light;
a memory configured to store data;
a controller configured to:
store first data in the memory, wherein the first data being indicative of at least one of one or more natural resources usage or one or more environmental impacts which is caused by operations carried out in relation to manufacturing of the lighting device;
prevent adjusting the first data stored in the memory;
store second data in the memory, wherein the second data being indicative of at least one of one or more natural resources usage or one or more environmental impacts which is caused by operations carried out in relation to the lighting device during the lifetime thereof after the manufacturing of the lighting device has been completed and wherein the second data at least are related to the use of the lighting device for generating light and/or sensing a surrounding space,
wherein the one or more environmental impacts are related to one or more of waste generation, release into air, release into water and release into soil;
wherein the first data comprise a data file comprising a list of resources and a plurality of entries, each defining a resource usage of a listed resource during manufacturing of the lighting device and wherein a listed resource of the list of resources is electricity;
wherein the second data comprise a data file comprising a list of resources and a plurality of entries, each defining a resource usage of a listed resource during operation of the lighting device for generating light and/or operating a sensing function and wherein a listed resource of the list of resources is electricity.

2. The lighting device according to claim 1, wherein the lighting device has a unique identifier and wherein the controller is further configured to obtain a unique identifier of the lighting device for obtaining at least part of the first data from a remote database using the unique identifier.

3. The lighting device according to claim 1, wherein the controller is further configured to determine a geographical location of the lighting device and to obtain at least a part of the second data related to the transportation of the lighting device to the geographical location.

4. The lighting device according to claim 1, wherein the lighting device further comprise an output interface configured to convey the first data and/or the second data to a user interface.

5. The lighting device according to claim 1, wherein release into air is the release of carbon dioxide.

6. The lighting device according to claim 5, wherein the environmental impact is expressed in carbon dioxide equivalent.

7. The lighting device according to claim 1, wherein the lighting device comprises an input interface for conveying a first input and/or a second input to the controller;
wherein the first input comprises the first data and/or wherein the second input comprises the second data;
wherein the controller determines the first data based on said first input and/or wherein the controller determines the second data based on said second input;
wherein the first input and the second input comprises a predetermined data format.

8. The lighting device according to claim 1, wherein the memory is configured to store a predetermined transformation function,
wherein the controller is configured to apply the predetermined transformation function to convert the first data and second data stored in the memory into an environmental impact value for at least one impact category.

9. The lighting device according to claim 8, wherein the predetermined transformation function is configured to first convert the resource usage of the lighting device according to the first data and the second data, respectively, into the resource usage of the lighting device in terms of an equivalent unit,
and subsequently convert the resource usage of the lighting device according to the first and second data, respectively, in terms of the equivalent unit into an environmental impact value for at least one impact category,
wherein the transformation function depends on a Life Cycle Assessment methodology.

10. The lighting device according to claim 5, wherein the list of resources further comprises one or more types of electrical components, one or more types of mechanical components, one or more types of optical components, one or more types of metallic materials, one or more types of inorganic materials and one or more types of polymer materials.

11. The lighting device according to claim 1, wherein the operations carried out in relation to the lighting device during the lifetime thereof are related to distribution of the lighting device, storage of the lighting device and operation of the lighting device.

12. A method for storing data in a memory of a lighting device according to claim 1, the method comprising:
storing first data in the memory, wherein the first data being indicative of at least one of one or more natural resources usage or one or more environmental impacts which is caused by operations carried out in relation to manufacturing of the lighting device;
preventing adjusting the first data stored in the memory after the manufacturing of the lighting device has been completed;
storing second data in the memory, wherein the second data being indicative of at least one of one or more natural resources usage or one or more environmental impacts which is caused by operations carried out in relation to the lighting device during the lifetime thereof after the manufacturing has been completed and wherein the second data at least are related to the use of the lighting device for generating light and/or sensing a surrounding space,
wherein the one or more environmental impacts are related to one or more of waste generation, release to air, release to water and release to soil;
wherein the first data comprise a data file comprising a list of resources and a plurality of entries, each defining a resource usage of a listed resource during manufacturing of the lighting device and wherein a listed resource of the list of resources is electricity; and
wherein the second data comprise a data file comprising a list of resources and a plurality of entries, each defining a resource usage of a listed resource during operation of the lighting device for generating light and/or operating a sensing function and wherein a listed resource of the list of resources is electricity.

13. A non-transitory computer readable medium comprising instructions which, when executed by at least one processor, implements the method of claim 12.

14. A lighting system selected from the group of a lamp, a luminaire, a projector device, a disinfection device, a photochemical reactor, an automotive lighting device, and an optical wireless communication device, comprising the lighting device according to claim 1.

15. A lighting system according to claim 14, wherein the lamp comprises a socket arranged for receiving mains power.
